(19) United States
(12) Patent Application Publication
(10) Pub. No.: US 2002/0140958 A1
(43) Pub. Date: Oct. 3, 2002

(54) Page description language adapted for direct printing of multiple file formats

(76) Inventor: Samuel M. Lester, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/823,201

(22) Filed: Mar. 29, 2001

(51) Int. Cl. B41B 1/00; G06F 15/00

(52) U.S. Cl. 358/1.13

(57) ABSTRACT

A page description language is adapted for direct printing of multiple file formats, including PDF and HTML. In the course of directly printing a PDF or HTML file, an interpreter reads commands from the PDF or HTML file. Where the PDL is PostScript, an error may result due to incompatibilities between the PostScript file format and PDF or HTML file formats. An error handler is called, which passes program control to a procedure that writes all the commands encountered prior to the error, the command causing the error, and the subsequent steam of commands to a file, typically on disk. When the file is complete, the procedure translates the file from PDF or HTML into the page description language. As the page description language commands are generated, they are sent back to the page description language interpreter, which treats them as a new job.

### TECHNICAL FIELD

This invention relates to a software-based solution allowing use of a page description language (PDL) to print files other than those for which the PDL was designed. More particularly, this invention relates to the use of a procedure, written in PostScript, which will print PDF (portable document format) and HTML (hypertext mark-up language) files.

### BACKGROUND

Recently, Adobe® PDF (portable document format) documents have become widely distributed. As a result, PDF is a well-known standard for electronic document distribution. PDF is a widely used file format that preserves the fonts, formatting, colors, and graphics of any source document, largely independent of the application and platform used to create it. PDF files are generally thought to be compact compared to files having similar information comprising PostScript or device ready bit commands. PDF files can be shared, viewed, navigated, and printed on any system with an Adobe® PDF application program or similar PDF reader application.

Similarly, HTML (hypertext mark-up language) documents are a standardized file type for use in the formation of much of the global computer network commonly known as the Internet. In particular, HTML files are used in the creation of web pages and web sites. HTML files may be downloaded, viewed, navigated and printed by any computer with an application program typically known as a browser. In printing either PDF or HTML files, the appropriate application program is opened by the user or operator. The application program reads the file, and the user selects the appropriate print command. A print driver, resident on the computer, translates the file into a page description language (PDL), such as PostScript or Hewlett Packard's PCL. The PDL file is then sent to the printer over a network. In some applications, the file may be translated to device ready bits (DRB) and sent to the printer.

This method of printing has at least two major drawbacks. First, it requires that the user have a licensed copy of the required application, launch that application, open the file and execute the required print commands. These requirements may result in cost, lost time and diminished productivity. In certain applications, wherein large numbers of documents have been archived and must be printed, this can be of major concern.

Secondly, translation of the file into a PDL or DRB results in a significant (e.g. many fold) expansion of the size of the file. This puts a correspondingly greater strain on the network.

Accordingly, there is a need for a printer operating a PDL to be able to print the PDF or HTML file directly, while minimizing the demands on an operator's time, minimizing host computer resource requirements including a licensed software application and a print driver, and minimizing network resource requirements.

### SUMMARY

This invention concerns a direct printing PDL, i.e. a page description language adapted for direct printing of multiple file formats, including Adobe PDF (portable document format), HTML (hypertext mark-up language) and similar documents. In a preferred application, the direct printing PDL is embodied as a procedure included within an error handler, or called by an error handler. The procedure and any modifications to the error handler are written in PostScript. The error handler or procedure can be installed on any PostScript printer in much in the same manner as a print job is sent to the printer.

The direct printing PDL allows a PDF or HTML document to be sent directly to the printer, without the requirement of an application to open the file-containing document, and without a print driver to translate the file. Upon receipt of the first commands within the file, the PostScript interpreter begins to send data to a stack. Because the document being printed is not a PostScript document, eventually the PostScript interpreter will encounter an unrecognized command, and will call its general error handler mechanism.

The error handler is able to recognize conditions consistent with an error caused by receipt of a PDF or HTML document. In response, the error handler directs program control to a procedure that continues to print the PDF, HTML or other file.

To continue the printing process, the procedure writes all the commands encountered prior to the error, the command causing the error, and the subsequent steam of commands to a file, typically on disk. When the file is complete, the procedure translates the file into PostScript. As the PostScript commands are generated, they are sent back to the PostScript interpreter, which processes the job.

### BRIEF DESCRIPTION OF THE DRAWINGS

The same numbers are used throughout the drawings to reference like features and components.

FIG. 1 is a view of a printing system having a workstation and a printer.

FIG. 2 is a block diagram of an exemplary network environment.

FIG. 3 is block diagram of the printing system that is implemented with the page description language adapted for direct printing of multiple file formats.

FIG. 4 is a block diagram that is exemplary of a printing system particularly adapted for direct printing of HTML files.

FIG. 5 is a flow diagram that describes a method by which an error handler and associated software procedure, implemented in page description language, may be used to print PDF and HTML files.

FIG. 6 is a flow diagram that describes an enhancement to the flow diagram of FIG. 5, particularly adapted for use in printing HTML files.

FIG. 7 is a diagram representing the screen of a video display, illustrating icons that are exemplary of a file transfer method and apparatus by which files may be transferred to a printer without use of an applications program and associated print driver.

### DETAILED DESCRIPTION

Overview

A direct printing multiple-format PDL, i.e. a page description language adapted for direct printing of multiple file formats, including Adobe PDF (portable document format), HTML (hypertext mark-up language) and similar documents is disclosed. In the course of directly printing a PDF and HTML file, the interpreter associated with the PDL (page description language) reads commands from the PDF or HTML file. Where the PDL (page description language) is PostScript, an error may result due to incompatibilities between the PostScript file format and PDF or HTML file formats. An error handler is called, which passes program control to a procedure that writes all the commands encountered prior to the error, the command causing the error, and the subsequent steam of commands to a file, in RAM or on disk. When the file is complete, the procedure translates the file from PDF or HTML into the page description language. As the page description language commands are generated, they are sent back to the page description language interpreter, which processes the job. While the direct-printing multiple-format PDL is described in the context of operation on a printer, operation in other contexts, and with devices other than printers, is possible.

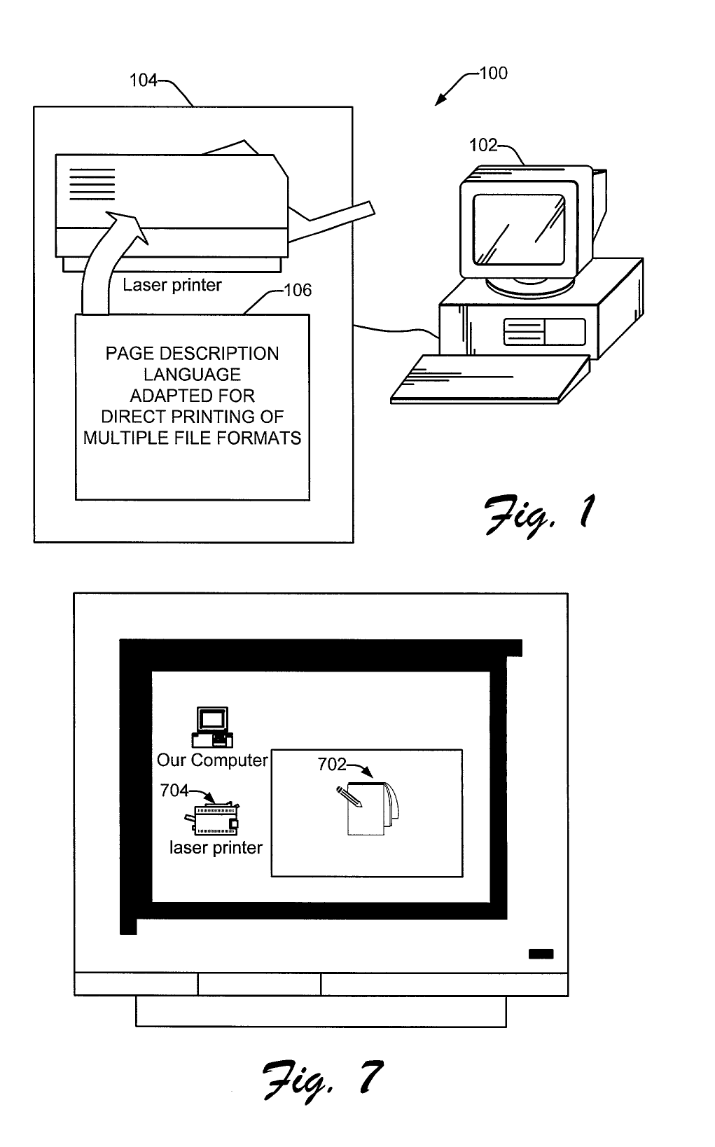

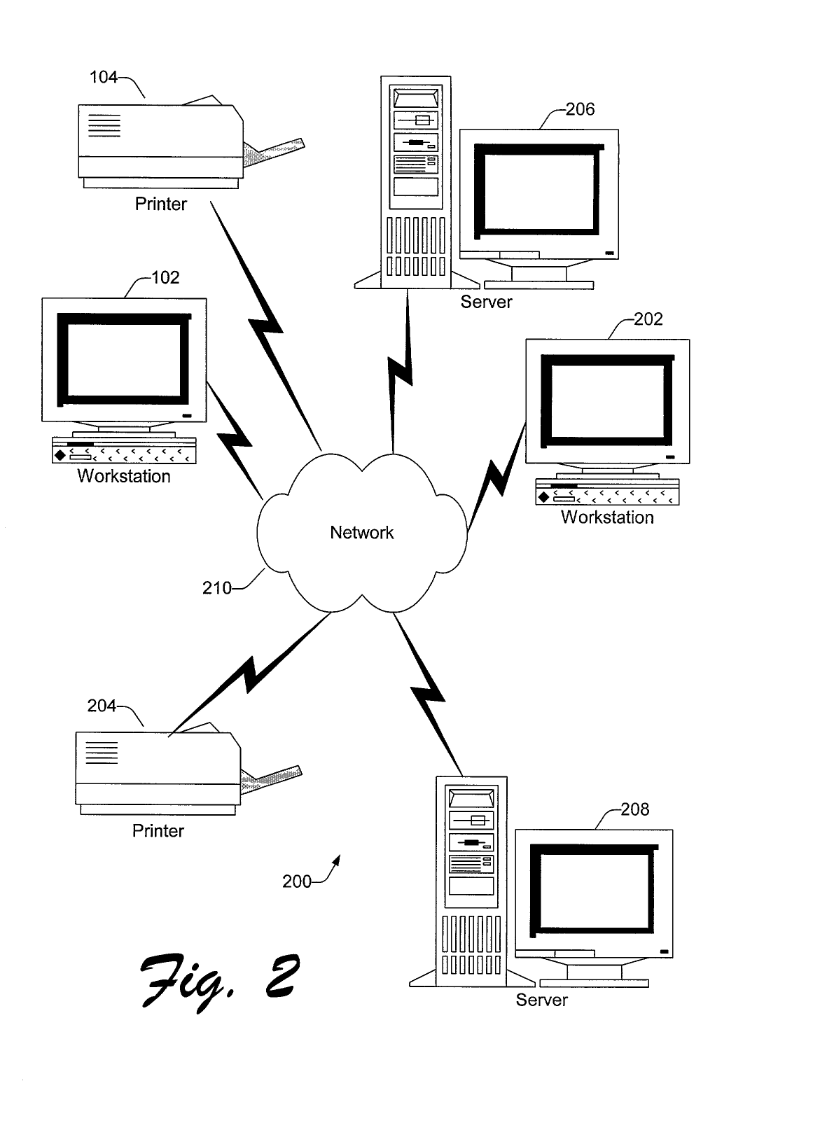

Exemplary Printing Environment FIG. 1 is an isometric view of a minimal printing system 100 having a workstation 102 connected to a laser printer 104 via a direct connection. The laser printer 104 is equipped with computer- or controller-readable media having computer- or controller-readable instructions, which when executed by a controller within the printer, support a page description language adapted for direct printing of multiple file formats, such as PDF and HTML. FIG. 2 illustrates a more generalized printing system 200 adapted for use in a network environment. Printer 204 of FIG. 2 is equipped with a page description language adapted for direct printing of multiple file formats in the same manner as printer 104. FIGS. 1 and 2 both illustrate exemplary printing environments in which the inventive techniques and structures described herein can be advantageously employed.

Continuing to refer to FIG. 2, the network environment can comprise multiple servers, workstations, and printers that are coupled to one another via a data communication network 210. In the example of FIG. 2, the network interconnects computer workstations 102 and 202, printers 104 and 204 and servers 206 and 208. Network 210 can be any type of network, such as a local area network (LAN) or a wide area network (WAN), using any type of network topology and any network communication protocol. For reasons of illustrative clarity, only a few devices are shown coupled to network 210. However, in some applications the network may have tens or hundreds of devices coupled to one another. Furthermore, network 210 may be coupled to one or more other networks, thereby providing coupling between a greater number of devices. Such can be the case, for example, when networks are coupled together via the Internet.

Servers 206 and 208 may be file servers, email servers, database servers, or any other type of network server. Workstations 102 and 202 can be any type of computing device, such as a personal computer. In the embodiment of FIG. 2, printers 104 and 204 can be laser printers. However, alternate embodiments can be implemented in connection with ink-jet printers or printers based on an alternative technology.

Exemplary Printer Architecture

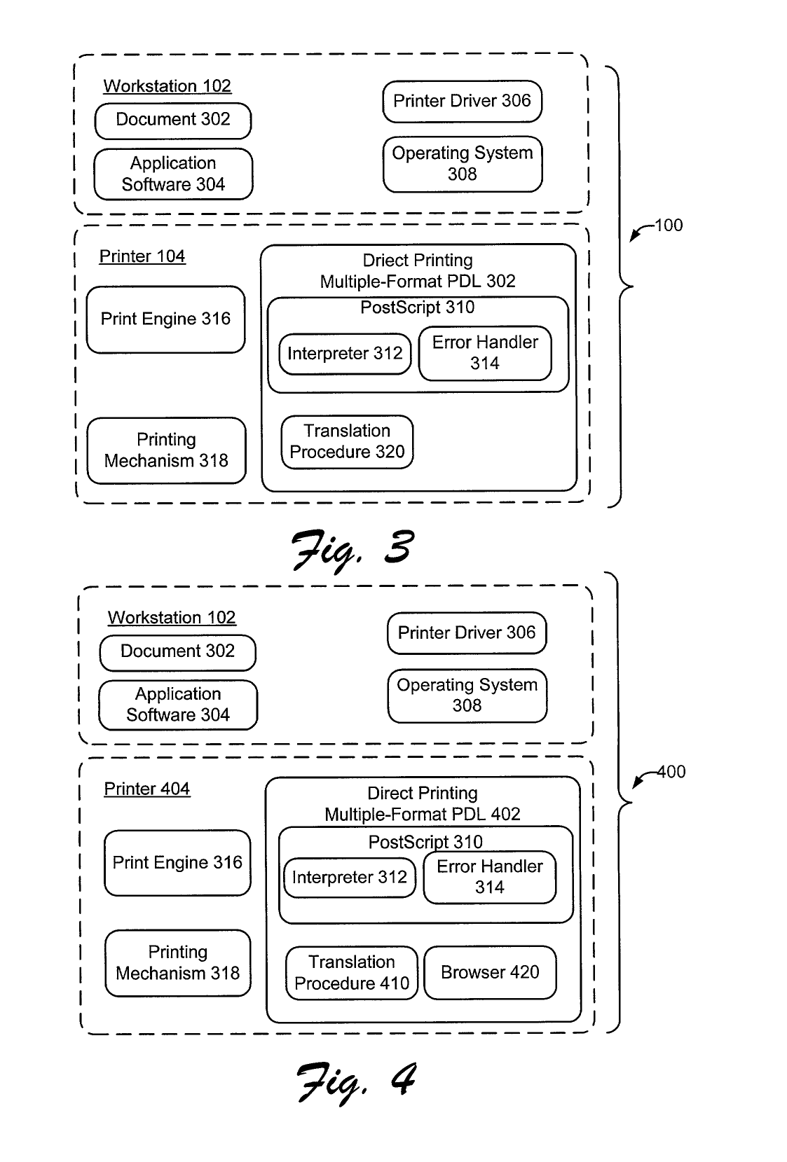

FIG. 3 shows a block diagram of the printing system 100 of FIG. 1, including the workstation 102 and printer 104. Other portions of the network, particularly seen in FIG. 2, are not shown for clarity of illustration.

The workstation 102 includes a document 302 that the user desires to print. The document was created by, or obtained by, application software 304, such as a word processor, spreadsheet, browser, or other application. Using the application software, the user may open the document. Using conventional print commands, the user is able to direct the printing of the document. When the print command is initiated, the printer driver 306 is called. Aided by facilities provided by the operating system 308, the printer driver is able to send the document, configured in a page description language such as PCL or PostScript, to the printer.

A direct-printing multiple-format PDL 302 is resident on the printer 104. The direct-printing multiple-format PDL comprises software instructions, defined on a computer-readable media, which when executed by the controller within the printer support the page description language 302. The direct-printing multiple-format PDL is a PDL that is adapted for direct printing, i.e. it is adapted to receive files that have not been processed by a print driver into page description language. Moreover, the direct-printing multiple-format PDL is adapted to receive a plurality of file formats, including PDF and HTML files.

A page description language is 310 is resident on the printer 104. In the case of FIG. 3, that page definition language is PostScript; however, an alternative page description language could be substituted, as desired. The document 302 is converted to a PostScript format by the printer driver 306, a process that typically greatly increases it size. The PostScript format document is then transferred over the network, where it is received within the printer by the interpreter 312 of the page description language 310. The interpreter outputs device ready bits to the print engine 316, which drive the print mechanism 318 in a manner that prints the document.

The above explanation assumes that the workstation has an application that can open the document, that the appropriate printer driver is available, and that the network has the bandwidth to support transfer of the document in PostScript format. However, in practice, it is frequently the case that this method of printing a document is not convenient, economic or possible. This is particularly true for HTML and Adobe® PDF documents. Accordingly, an aspect of this invention is to provide a means to print HTML and PDF files without an application, without an associated print driver, and without utilizing the network resources required to transfer a file enlarged by a print driver into a page description language format.

Continuing to refer to FIG. 3, it can be seen that an error handler 314 is part of the page description language, and that the error handler is called in the event that an error occurs during the printing process. Due to incompatibilities between PostScript and the file formats used by PDF and HTML files, it is a characteristic of PostScript that receipt of a PDF or HTML file will result in an error handler 314 being called.

The error handler 314 is configured to identify conditions consistent with the possibility that the error is a result of a PDF or HTML file sent to the interpreter. For example, such modifications would filter out error conditions resulting from mechanical failure of the print mechanism, and other similar possible causes of an error condition. Having determined that the error was the result of conditions consistent with receipt of a PDF or HTML file, the error handler calls a translation procedure 320, as seen in FIG. 3.

The translation procedure 320 is written in the language of the page description language. In the example of FIG. 3, the translation procedure 320 is written in PostScript. PostScript is a fully developed programming language, capable of performing a wide variety of tasks, such as simple arithmetic, more complex mathematics, and tasks involving character and string manipulation, as well as tasks requiring calls to the operating system.

Accordingly, the translation procedure 320, written in PostScript, is able to translate the commands making up a PDF or HTML file into the PostScript commands needed to make up an equivalent PostScript file.

A procedure written in PostScript is far more easily implemented than one written in machine code on an assembler for use in firmware. Additionally, a procedure written in PostScript is far more easily installed on a PostScript printer than a procedure written in “C” or “C++.” Accordingly, the exemplary procedure of FIG. 3 is written in PostScript when adapted for a PostScript printer, and in an alternative page description language when written for a printer operating an alternative page description language.

Referring to FIG. 4, the printing system 400 is similar to the printing system 100, seen in FIG. 3. The printing system contains a direct-printing multiple-format PDL 402 that comprises software instructions, defined on a computer-readable media, which when executed by the controller within the printer support the page description language 402.

The translation procedure 410 is particularly suited for translation of file types found on the Internet generally, and associated with HTML documents in particular. The translation procedure 410 is therefore able to translate into a page description language, such as PostScript, the JIF and JPEG graphical files typically associated with many, if not most, HTML documents.

Printing system 400 is further adapted to include a browser 420, which is defined in controller-readable media contained within the printer 104. The browser is able to obtain files from the Internet in a manner similar to known browsers, such as the Microsoft® Internet Explorer and the Netscape's Navigator.

The translation procedure 410 and browser 420 are written in the PostScript language, although they could alternatively be written in C or C++. Writing the browser in PostScript has several advantages. First, due to the high level nature and fully developed functionality, the development is substantially easier than a browser written with an assembler and embedded in ROM for operation in the firmware. Secondly, where the browser is implemented in PostScript, it is easily installed in much the same manner as the translation procedure 320, or the enhanced error handler 314.

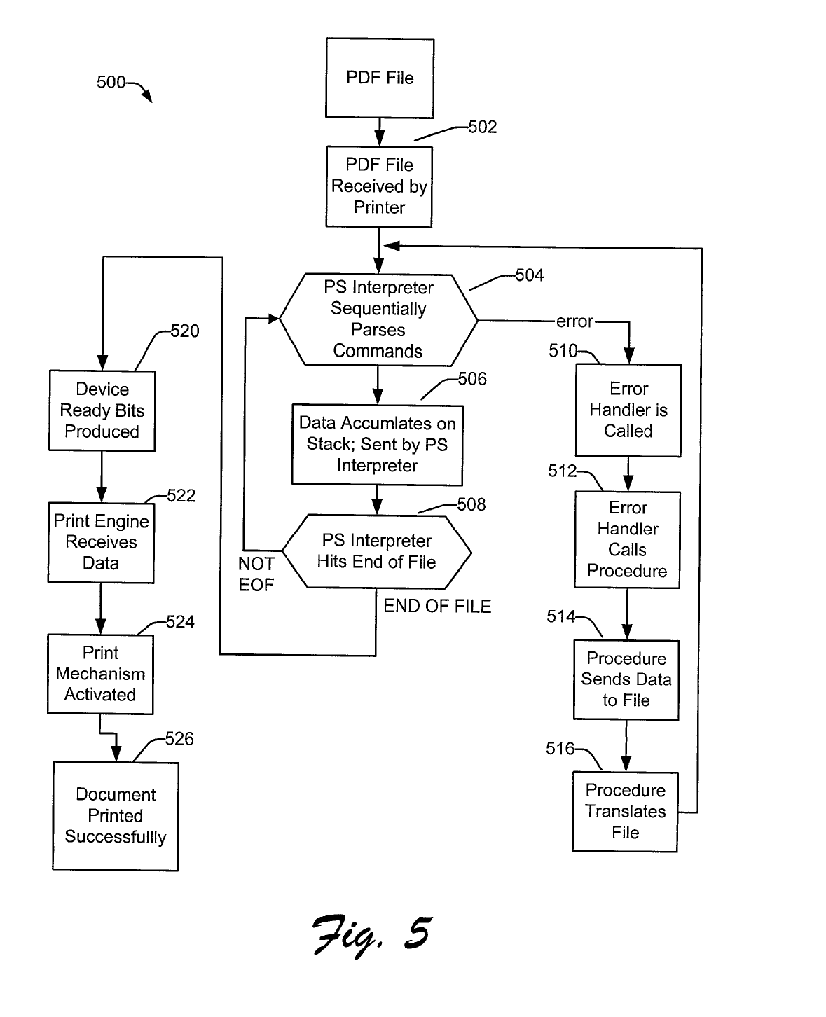

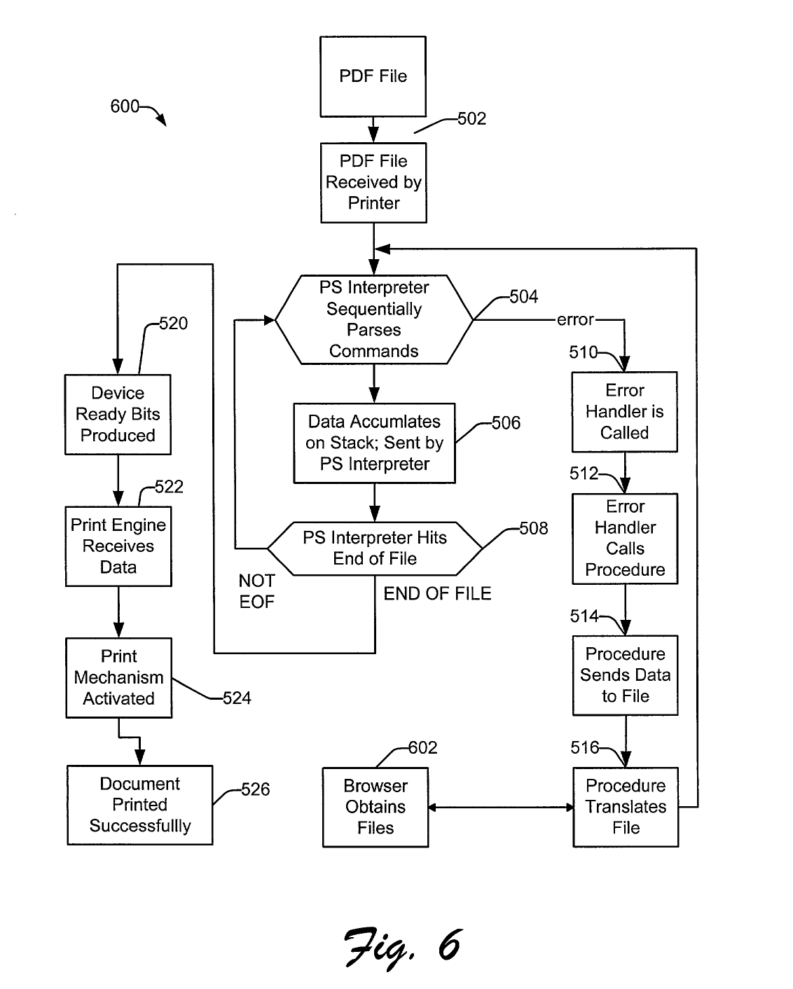

Exemplary Method of Printing PDF Documents FIG. 5 shows an operation 500 of a page description language adapted for direct printing of multiple file formats, wherein a PDF file is printed. The operation 600 described in FIG. 6 is also adapted for use with HTML files, due to support for the acquisition over the Internet of files, such as graphics, which greatly enhance many HTML documents. The blocks illustrated in FIGS. 5 and 6 may be implemented in software and/or hardware.

In the operations 500, 600 of FIGS. 5 and 6, instructions configured to support the operation and functionality of each block may be computer- or controller-readable statements contained on computer- or controller-readable media. The statements, when read by the controller, micro-controller, CPU or other device cause the printer to implement the functionality of each block.

At block 502, the printer receives a PDF file. Referring to FIGS. 3 and 4, the PDF file may be sent by using the operating system 308. In particular, in FIG. 7 it can be seen that an icon 702 representing a document 302 may be moved into an icon 704 representing a printer 204. This action transfers the document to the printer, using appropriate calls to the operating system, without the use of an application or printer driver and with only minimal involvement of the user.

At block 504, the PostScript interpreter begins to parse the commands of the PDF file in a sequential manner. It is typically the case that similarity between the PDF and PostScript file formats allows a number of commands from the PDF file to be interpreted without error by the PostScript interpreter. If there is no error, the commands accumulate on a data structure, such as a stack, at block 506. If there is an error, the error handler is called at block 510.

At block 506, data resulting from commands from the PDF file that has been interpreted by the PostScript interpreter, are sent to a stack or other data structure. The data begin to accumulate, as the PDF commands are parsed as block 504.

At block 508, the PostScript interpreter determines if the end of the file is encountered. If the end of file is not encountered, the interpreter returns to block 504, where an additional command from the PDF file is interpreted. If the end of the file is encountered, the device ready bits are produced at block 520, the print engine receives data at block 522, the print mechanism is activated at block 524 and the document is printed at block 526.

At block 504, the PostScript interpreter may encounter an error. It is typical that fairly early in the process of interpreting the commands contained within the PDF file, an error is in encountered. The error results because the PostScript interpreter is designed to interpret PostScript files, and will therefore not be able to interpret a non-PostScript file. As a result of the error, the error handler is called at block 510.

A preferred error handler 314 identifies conditions consistent with the possibility that the error is a result of receipt by the interpreter of a PDF or HTML. For example, such modifications would filter out error conditions resulting from mechanical failure of the print mechanism, and other similar possible causes of an error condition. If the error handler determines that the error was the result of conditions consistent with receipt of a PDF or HTML file, the error handler calls a procedure at block 512. If the error handler determines that the error was not the result of conditions consistent with receipt of a PDF or HTML file, the error handler performs in a conventional manner.

At block 514 the procedure 320 sends the commands interpreted prior to the command that caused the error, the command that caused the error, and all subsequent commands to a file. Translation of a PDF file generally requires that the entire file be available prior to translation. This is because a catalog of objects and their bytes sizes is found at the end of the file. The file may be contained in RAM, or on disk if RAM is unavailable. This file will be used as the data input to the translation procedure at block 516. Having formed the file, the procedure ends the printing process started at block 502.

At block 516 the procedure 320 translates the file from a PDF or HTML format into a PostScript file, suitable for printing by a PostScript printer. The file may be much more rapidly translated where it is in RAM, or more slowly translated where it is on disk. As the file is translated, PostScript commands are generated as the output of the translation process. These PostScript commands are input to the PostScript interpreter at block 504, thereby causing the commands to be sequentially parsed. Upon completion of the translation, a sequence of PostScript commands that is equivalent to the contents of the PDF or HTML file initially sent to block 502 will have been received by the PostScript interpreter.

Exemplary Method of Printing HTML Documents FIG. 6 shows an operation 600 of the page description language adapted for direct printing of multiple file formats, including HTML documents. The method of FIG. 6 is similar to the method of FIG. 5. However, due to differences in the format of PDF and HTML files, two principle differences exist.

First, unlike PDF files, HTML files do not contain information at the end of the file required for translation of the beginning of the file. As a result, at block 514 the first part of the file assembled may be sent to the translation procedure at block 516 before the end of the file is received. This allows for the file to be translated more rapidly.

Second, an additional enhancement provides for network acquisition of files associated with HTML documents. As noted above, FIG. 5 describes a method of printing PDF files and those HTML files wherein all of the information required to print the file is contained within the file. However, a large number of HTML files have URLs (uniform resource locations) located within the text of the HTML. The URL can be thought of a pointer to a location within the Internet wherein additional files are located, typically including graphical files that are required to fully display the HTML document. To obtain graphical and other files, a browser 420, such as that seen in FIG. 4, is provided. The operation of the browser is seen at block 602 in FIG. 6, wherein files needed to complete the printing process of the HTML document can be obtained over the Internet.

As seen in block 602 of FIG. 6, when the translation procedure encounters a URL within the HTML file, the URL is given to the browser. The browser 420 obtains and returns the file associated with the URL from the Internet. Typically, these files are JIFs, JPEGs and other file types, which the translation procedure 410 is able to translate to PostScript commands at block 516. The information from the file, obtained by the browser and translated to PostScript by translation procedure 410, is then added to the data output by block 516, and sent to block 504.

Although the invention has been described in language specific to structural features and/or methodological blocks, it is to be understood that the invention defined in the appended claims is not necessarily limited to the specific features or blocks described. Rather, the specific features and blocks are disclosed as exemplary forms of implementing the claimed invention.

1. A method for operating a printer, comprising:
writing a document to a file;
translating the file, using a procedure, into a sequence of commands for a page description language; and
sending the page description language commands to a page description language interpreter.

2. A method as recited in claim 1, additionally comprising receiving an error message in response to an unrecognized command in the document.

3. A method as recited in claim 1, wherein the document is of a type selected from a group of documents comprising a PDF document and an HTML document.

4. A method as recited in claim 1, wherein the procedure is written in the page description language.

5. A method as recited in claim 4, wherein the page description language is PostScript.

6. A method as recited in claim 1, additionally comprising obtaining, over a network, files referenced by the file.

7. A method for printing a document using a printer having an interpreter supported by a page description language, comprising:
calling an error handler in response to an unrecognized command in the document;
writing statements prior to the unrecognized statement, to a file;
writing a data stream, comprising the unrecognized statement and subsequent statements in the document, to the file;
translating the file into a sequence of page description language commands; and
sending the page description language commands to the interpreter.

8. A method as recited in claim 7, wherein the document is of a type selected from a group of documents comprising a PDF document and an HTML document.

9. A method as recited in claim 7, wherein the procedure is written in the page description language.

10. A method as recited in claim 9, wherein the page description language is PostScript.

11. A method for handling errors generated by a page description language in the course of printing a document, comprising:
translating the document into a sequence of commands for a page description language; and
sending the page description language commands to a page description language interpreter.

12. The method for handling errors in a page description language as recited in claim 11, wherein the translation is performed by a procedure written in the page description language.

13. A method for printing a non-PostScript document with a PostScript printer, comprising:
calling an error handler in response to a non-PostScript command in the non-PostScript document;
writing the document to a file;
translating the file into a sequence of PostScript commands; and
sending the PostScript commands to a PostScript interpreter.

14. A method as recited in claim 13, wherein the document is of a type selected from a group of documents comprising a PDF document and an HTML document.

15. A method as recited in claim 13, wherein the translation is done by a procedure written in PostScript.

16. A page description language embodied on a computer-readable media having computer-readable instructions thereon which, when executed by a device, cause the device to:
respond to an unrecognized command in a document;
translate the document into a sequence of commands for use by a page description language; and
send the sequence of commands for use by the page description language to a page description language interpreter.

17. A page description language as recited in claim 16, wherein the document is of a type selected from a group of documents comprising a PDF document and an HTML document.

18. A page description language as recited in claim 16, wherein the error handler is written in the page description language.

19. A method as recited in claim 16, wherein the device is additionally caused to:
obtain at least one additional file, referenced by the file, over a computer network.
